(19) United States
(12) Patent Application Publication
(10) Pub. No.: US 2025/0068960 A1
(43) Pub. Date: Feb. 27, 2025

(54) REFINING MACHINE LEARNING MODELS TO MITIGATE ADVERSARIAL ATTACKS IN AUTONOMOUS SYSTEMS AND APPLICATIONS

(71) Applicant: NVIDIA CORPORATION, Santa Clara, CA (US)

(72) Inventor: Chong YU, Shanghai (CN)

(21) Appl. No.: 18/003,289

(22) PCT Filed: Nov. 11, 2022
(86) PCT No.: PCT/CN2022/131339

§ 371 Date: Dec. 23, 2022

(51) Int. Cl. G06N 20/00; G06V 10/764

(52) U.S. Cl. CPC G06N 20/00; G06V 10/764

(57) ABSTRACT

In various examples, a technique for processing sensor data includes generating, using a machine learning model and based on a first sensor data instance, a first set of confidences for a set of output types and a first adversarial confidence that represents a likelihood that the first sensor data instance is adversarial. The technique also includes determining that the first sensor data instance is adversarial based on the first adversarial confidence. The technique further includes transmitting a first indication that the first sensor data instance is adversarial to one or more downstream components such that the one or more downstream components perform one or more operations based at least on the indication.

### BACKGROUND

A visual autonomous or semi-autonomous driving system analyzes sensor data to understand the environment around an autonomous or semi-autonomous vehicle (e.g., a self-driving car). These systems commonly use machine learning models that process the sensor data collected using sensors on the vehicle, and use the output thereof to perform various operations-such as to detect, classify, and/or track pedestrians, animals, buildings, road conditions, traffic signs, barriers, other vehicles, and/or other objects or scenarios around the vehicle. This output may be used to guide driving or control decisions to aid in operation of the vehicle in a safe manner.

In some instances, the operation of a visual driving system can be impeded by an adversarial attack that causes the machine learning models to generate incorrect, inaccurate, or imprecise predictions. For example, an adversarial attack can involve anywhere from a slight to a significant perturbation to the color, shape, text, or other visual attributes of an environmental feature-such as a traffic sign, a vehicle or other dynamic object, a road marking, etc. In an example with a traffic sign, these perturbations can manifest in a manner that causes a machine learning model to incorrectly categorize or classify the traffic sign (e.g., by predicting that the speed limit shown on the traffic sign is significantly higher or lower than the actual speed limit on the traffic sign). When such an adversarial attack succeeds, the incorrect prediction generated by the visual driving system can lead to improper decisions by one or more downstream components or systems of the vehicle.

Existing approaches for reducing the susceptibility of a visual driving system to adversarial attacks involve augmenting or enhancing a training dataset used to train a machine learning model prior to deployment in the visual driving system. These approaches can also, or instead, use an ensemble of multiple machine learning models to generate predictions that are subsequently used by the visual driving system to make or guide driving decisions. However, these techniques do not guarantee that the machine learning model(s) is able to defend against adversarial attacks manifested in sensor data, which are typically perturbed in specific ways to cause the machine learning model(s) to output incorrect predictions.

As such, a need exists for more effective techniques for improving the robustness of machine learning models—such as those included visual driving systems—to adversarial attacks.

### SUMMARY

Embodiments of the present disclosure relate to techniques for refining machine learning models to mitigate adversarial attacks. The techniques described herein include generating, using a machine learning model and based on a first sensor data instance, a first set of confidences for a set of output types and a first adversarial confidence that represents a probability that the first sensor data instance is adversarial. The technique also includes determining that the first sensor data instance is adversarial based on the first adversarial confidence. The technique further includes transmitting a first indication that the first sensor data instance is adversarial to one or more downstream components such that the one or more downstream components may perform one or more operations based at least on the indication.

One technical advantage of the disclosed techniques relative to conventional solutions is that a machine learning model is able to detect, account for, and aid in the notification of adversarial attacks on the system. Accordingly, a system that uses the output of such a machine learning model may be safer and more resistant to adversarial attacks than conventional systems that include machine learning models that have not been trained to recognize and/or defend against adversarial attacks. Another technical advantage of the disclosed techniques is a reduction in computational overhead and resource consumption, compared with prior art approaches that use an ensemble of multiple machine learning models to guard against adversarial attacks.

### BRIEF DESCRIPTION OF THE DRAWINGS

The present systems and methods for refining machine learning models to mitigate adversarial attacks are described in detail below with reference to the attached drawing figures, wherein:

FIG. 1 illustrates a computing device configured to implement one or more aspects of various embodiments;

FIG. 2 is a more detailed illustration of the evaluation engine, refinement engine, and execution engine of FIG. 1, according to various embodiments;

FIG. 3 illustrates a flow diagram of a method for fine-tuning a machine learning model using adversarial data, according to various embodiments;

FIG. 4 illustrates a flow diagram of a method for processing sensor data, according to various embodiments;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

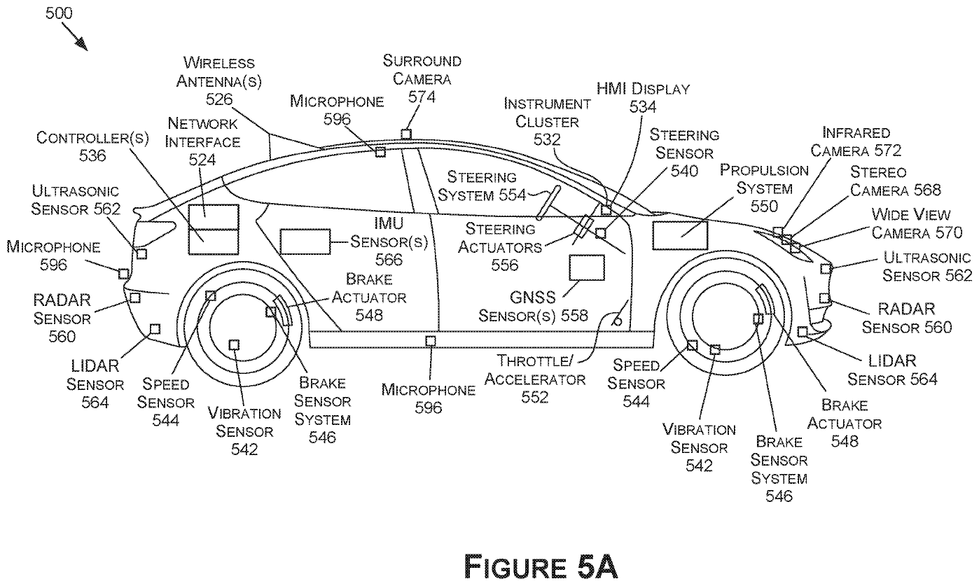

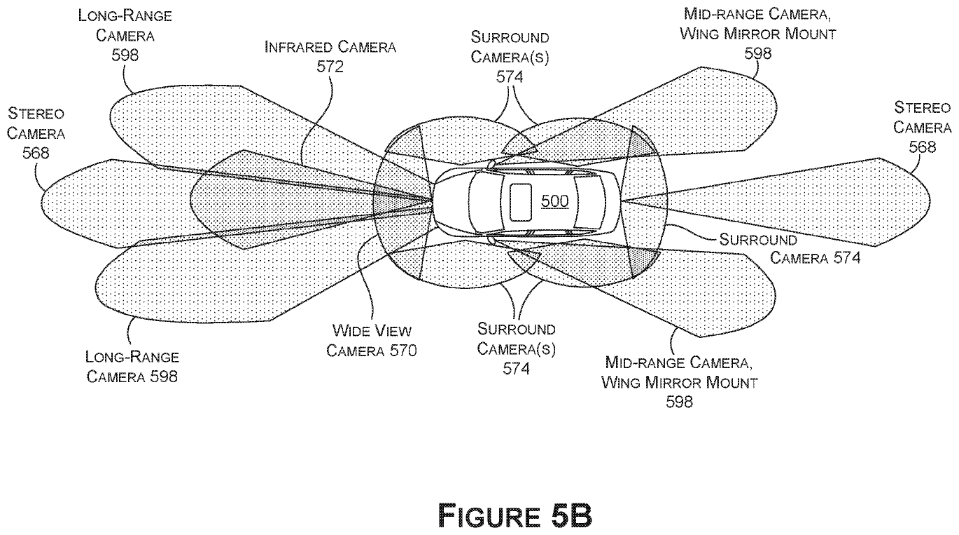

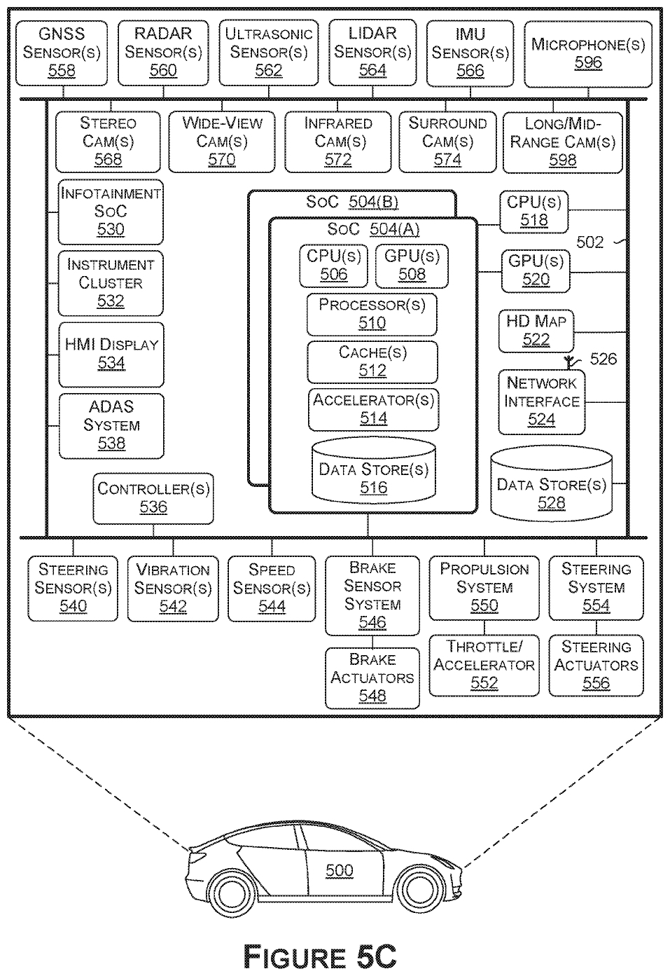

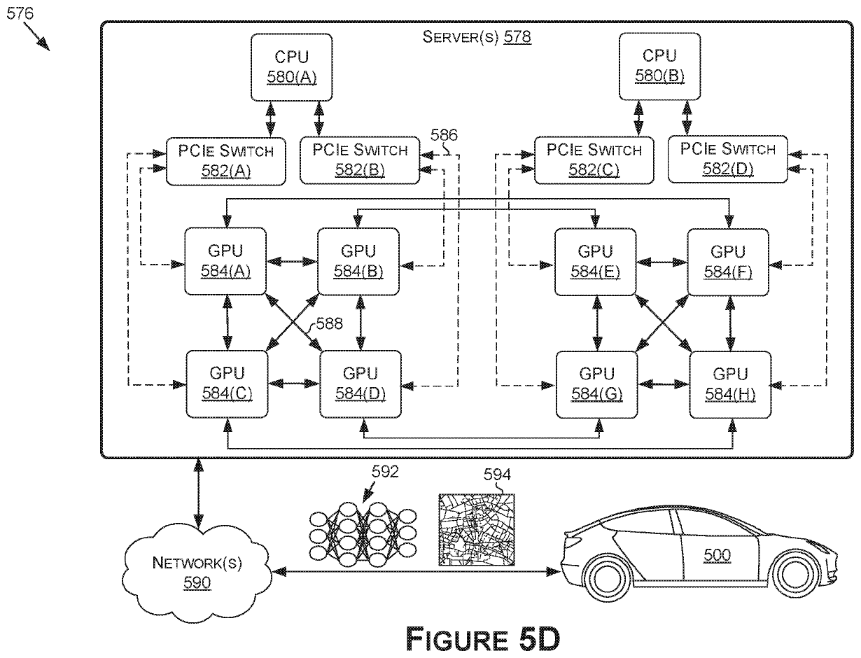

Systems and methods are disclosed for mitigating adversarial attacks via refinement of machine learning models. Although the present disclosure may be described with respect to an example autonomous or semi-autonomous vehicle or machine 500 (alternatively referred to herein as “vehicle 500” or “ego-500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to mitigating adversarial attacks on machine learning models employed in autonomous or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where adversarial attacks may occur.

As discussed herein, the correct operation of a visual driving system in an autonomous or semi-autonomous vehicle can be affected by an adversarial attack that causes one or more machine learning models of the system to generate incorrect predictions. When such an adversarial attack succeeds, these incorrect predictions can cause the autonomous or semi-autonomous vehicle or machine (or any other system to which an adversarial attack is aimed) to perform one or more operations improperly or not at a desired or required level of accuracy or precision.

To improve the ability of visual driving systems to guard against adversarial attacks, the disclosed techniques perform fine-tuning of a pre-trained machine learning model using adversarial images (or other types of adversarial data, such as LiDAR data, RADAR data, ultrasonic data, and/or data generated using any other sensor type, such as but not limited to those described herein with respect to the vehicle 500 of FIGS. 5A-5D). The adversarial images can be generated by perturbing a set of original images based on one or more types of adversarial attack techniques. Once generated, the adversarial images may be processed using the pre-trained machine learning model, and the predictions generated using the pre-trained machine learning model may be compared to ground truth data (e.g., labels) corresponding to the original images from which the adversarial images were generated. Based on these comparisons, the adversarial images are divided into a “clean” dataset of adversarial images for which the pre-trained machine learning model generated correct predictions and an “adversarial” dataset of adversarial images for which the pre-trained machine learning model generated incorrect predictions.

The machine learning model is then refined using the dataset of adversarial images and corresponding ground truth. During the refinement process, adversarial images in the clean dataset may be processed using the machine learning model, and the machine learning model may be trained based on losses between predictions generated using the machine learning model based on the adversarial images and the ground truth for the original images that correspond to the adversarial images.

Adversarial images in the adversarial dataset may also be processed using the machine learning model, and the machine learning model may be trained based on losses between predictions generated using the machine learning model based on the adversarial images and ground truth data that is determined based on perturbation strengths associated with the adversarial images. More specifically, adversarial images that are in the adversarial dataset and associated with perturbation strengths of less than a threshold amount may be assigned labels for the corresponding original images, and adversarial images that are in the adversarial dataset and associated with perturbation strengths of greater than the threshold amount may be assigned an “adversarial label” that indicates that the corresponding images (or regions of images) are to be disregarded, processed differently, etc. when determining one or more actions to be performed using the output of the machine learning model in the visual driving system. The machine learning model may be trained based on losses between predictions generated using the machine learning model from the adversarial images and the corresponding ground truth labels.

After the machine learning model has been trained using the adversarial images and corresponding ground truth, the machine learning model can be deployed—e.g., in a visual driving system—to generate predictions for additional images. For example, the machine learning model may be used to detect and/or track objects in the vicinity of a self-driving car during operation of the self-driving car. The output of the machine learning model may be provided to one or more downstream components that generate commands and/or signals that are used to operate the self-driving car.

One technical advantage of the disclosed techniques relative to the conventional solutions is that a machine learning model is able to detect and, at least in some cases, aid in correcting for adversarial data that attempts to cause the machine learning model to operate incorrectly. Accordingly, a system that uses the output of the machine learning model may be safer and more resistant to adversarial attacks than conventional systems that include machine learning models that have not been trained to recognize and/or defend against adversarial attacks. Another technical advantage of the disclosed techniques is a reduction in computational overhead and resource consumption, compared with conventional approaches that use an ensemble of multiple machine learning models to guard against adversarial attacks.

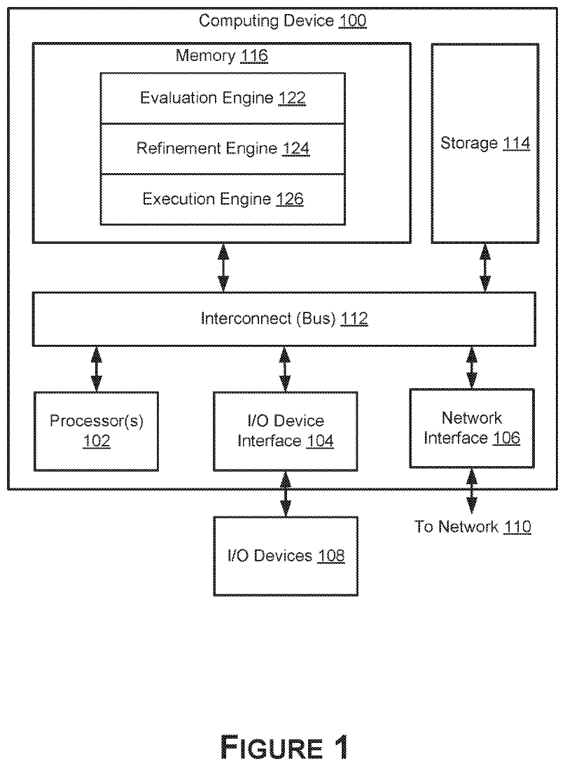

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, and/or any other type of computing device configured to receive input, process data, and optionally display images, and is suitable for practicing one or more embodiments. Computing device 100 is configured to run an evaluation engine 122, a refinement engine 124, and an execution engine 126 that may reside in a memory 116. It is noted that the computing device described herein is illustrative and that any other technically feasible configurations fall within the scope of the present disclosure. For example, multiple instances of evaluation engine 122, refinement engine 124, and/or execution engine 126 may execute on a set of nodes in a distributed and/or cloud computing system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a parallel processing unit (PPU), a data processing unit (DPU), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, and/or a microphone, as well as devices capable of providing output, such as a display device and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Evaluation engine 122, refinement engine 124, and/or execution engine 126 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs that can be executed by processor(s) 102 and application data associated with said software programs, including evaluation engine 122, refinement engine 124, and/or execution engine 126.

Evaluation engine 122 includes functionality to evaluate the performance of a machine learning model in generating predictions from adversarial examples. For example, evaluation engine 122 may generate a set of adversarial images by applying various types of perturbations to a set of original (e.g., captured, synthetic, etc.) images. Evaluation engine 122 may input each adversarial image into a neural network that detects objects in images. Evaluation engine 122 may also compare the output generated using the neural network with a corresponding ground truth data (e.g., a label, annotation, etc.) corresponding to the original image from which the adversarial image was generated. Evaluation engine 122 may then divide the adversarial images into two or more datasets. A first dataset may include adversarial images for which the neural network correctly predicted the output for the corresponding original image, and a second dataset may include adversarial images for which the neural network did not correctly predict the output for the corresponding original image.

Refinement engine 124 performs additional training and/or fine-tuning of the machine learning model using the datasets generated using the evaluation engine 122. Continuing with the above example, the refinement engine 124 may train (e.g., update one or more parameters of) the neural network in a way that minimizes a first loss between predictions generated using the machine learning model based on adversarial images in the first dataset and the ground truth (labels) for the corresponding original images. Refinement engine 124 may train the neural network to predict different labels for different subsets of adversarial images in the second dataset. More specifically, refinement engine 124 may divide the second dataset into a first subset of adversarial images associated with perturbation strengths that exceed a threshold amount and a second subset of adversarial images associated with perturbation strengths below a threshold amount (which may be the same or different threshold as the adversarial images). Refinement engine 124 may train the neural network in a way that minimizes a second loss between predictions generated using the machine learning model from adversarial images in the first subset and an “adversarial label” indicating that the images (or regions of images) are to be disregarded or processed differently (e.g., by ignoring portions of the images identified as adversarial) when determining actions to be performed by one or more downstream components. Refinement engine 124 may additionally train the neural network in a way that minimizes a third loss between predictions generated using the machine learning model from adversarial images in the second subset and the labels or other ground truth for the corresponding original images.

Execution engine 126 uses the trained machine learning model to generate predictions for additional data. For example, execution engine 126 may deploy and execute the trained machine learning model within an autonomous or semi-autonomous software driving stack (“drive stack”) of an autonomous or semi-autonomous machine. During operation of the machine, the trained machine learning model may be used to perform any of various operations, such as to detect and track objects in images captured using cameras of the machine. The output of the machine learning model may be provided to one or more downstream components (e.g., control components, behavior planning components, actuation components, world model management components, etc.) that use the output to generate one or more commands and/or make other decisions related to the operation of the machine. Consequently, evaluation engine 122, refinement engine 124, and execution engine 126 may be used to improve the robustness of machine learning models and/or, more generally, driving systems, against adversarial attacks, as discussed in further detail herein.

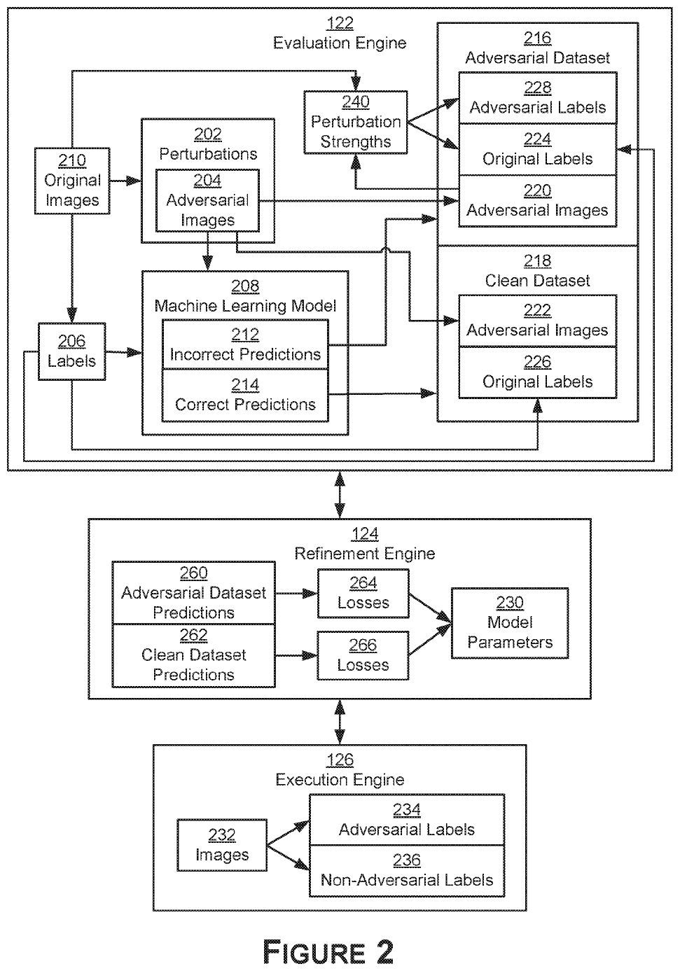

FIG. 2 is a more detailed illustration of evaluation engine 122, refinement engine 124, and execution engine 126 of FIG. 1, according to various embodiments. As mentioned above, evaluation engine 122, refinement engine 124, and execution engine 126 operate to improve the robustness of a machine learning model 208 against adversarial attacks. Each of these components is described in further detail herein.

In some embodiments, the machine learning model 208 includes a pre-trained model that is used to generate predictions related to a set of images 232. For example, machine learning model 208 may include one or more recurrent neural networks (RNNs), convolutional neural networks (CNNs), deep neural networks (DNNs), deep convolutional networks (DCNs), residual neural networks (ResNets), graph neural networks, autoencoders, transformer neural networks, deep stereo geometry networks (DSGNs), stereo R-CNNs, and/or other types of artificial neural networks or components of artificial neural networks. Machine learning model 208 may also, or instead, include a regression model, support vector machine, decision tree, random forest, gradient-boosted tree, naïve Bayes classifier, Bayesian network, Hidden Markov model (HMM), hierarchical model, ensemble model, clustering technique, and/or another type of machine learning model that does not utilize artificial neural network components. Machine learning model 208 may be pre-trained to generate outputs that may be used to perform any of various operations, such as to detect and/or track objects, detect and/or classify road conditions, and/or perform other functions with respect to the images 232. Machine learning model 208 may also, or instead, be pre-trained to aid in the prediction of trajectories, paths, distances, and/or behaviors of vehicles, pedestrians, and/or other moving or dynamic objects. Machine learning model 208 may also, or instead, be pre-trained to aid in generating a trajectory for navigating an autonomous or semi-autonomous vehicle or machine, given a destination, available routes to the destination, detected obstacles, and/or other criteria.

As mentioned herein, evaluation engine 122 analyzes the performance of machine learning model 208 in processing a set of adversarial images 204. As shown in FIG. 2, evaluation engine 122 generates adversarial images 204 by applying a set of perturbations 202 to a set of original images 210. For example, evaluation engine 122 may use a set of known adversarial attack techniques (e.g., fast gradient step method (FGSM), projected gradient descent (PGD), limited-memory Broyden-Fletcher-Goldfarm-Shannon (L-BGFS), Carlini & Wagner, Jacobian-based Saliance Map Attack (JSMA), DeepFool, etc.) to apply perturbations 202 to original images 210 in order to generate a corresponding set of adversarial images 204. Evaluation engine 122 may also, or instead, use perturbations 202 that are specified, selected, or defined by one or more users to convert original images 210 into adversarial images 204. Evaluation engine 122 may also, or instead, apply multiple perturbations 202 to a single original image to generate a corresponding adversarial image, interpolate between two or more perturbations 202 to generate a perturbation that is applied to the original image, and/or otherwise combine multiple perturbations 202 to generate the adversarial image from the original image.

Perturbations 202 include changes to pixel values in original images 210 that can cause machine learning model 208 to generate incorrect predictions 212. For example, perturbations 202 may include changes to pixel values in original images 210 that are imperceptible to humans, but that are designed to cause machine learning model 208 to generate incorrect or imprecise outputs-such as to incorrectly predict the locations and/or classes associated with objects in original images 210. In another example, perturbations 202 may include changes to pixel values in certain “patches” or “regions” of original images 210 that can cause machine learning models 208 to detect ghost objects, mis-classify objects in original images 210, and/or otherwise generate incorrect or imprecise predictions 212. In a third example, perturbations 202 may include changes to original images 210 that are both perceptible to humans and capable of causing machine learning model 208 to generate incorrect predictions 212. In a fourth example, perturbations 202 may include extensive changes to original images 210 that would cause both humans and machine learning models 208 to incorrectly predict object classes, object locations, and/or other attributes associated with objects in original images 210.

In one or more embodiments, original images 210 include images from a training dataset for machine learning model 208. For example, in an automotive use case, original images 210 may include images that depict roads, traffic signs, vehicles, pedestrians, intersections, lanes, obstructions, and/or other objects in the vicinity of a vehicle. Evaluation engine 122, refinement engine 124, execution engine 126, and/or another component may train machine learning model 208 to detect and/or track objects in original images 210 based on bounding shapes, classes, and/or other labels 206 for the objects.

Alternatively, original images 210 may include images that have not been used to train the machine learning model 208. For example, in the automotive use case, original images 210 may include images of roads, traffic signs, vehicles, pedestrians, intersections, lanes, obstructions, and/or other objects that are distinct from those depicted in the images within the training dataset for machine learning model 208. Original images 210 may also, or instead, include augmentations of the images within the training dataset, synthetic images, and/or other types of images that are visually distinct from those in the training dataset.

After generating adversarial images 204 that include perturbations 202 of original images 210, evaluation engine 122 may input or apply the adversarial images 204 (e.g., image data or sensor data representative thereof, either with or without pre-processing) into the machine learning model 208. Evaluation engine 122 compares the output generated using the machine learning model 208 from each adversarial image with one or more labels 206 (or other ground truth data) for the original image from which the adversarial image was generated. Evaluation engine 122 uses the results of the comparison to identify a set of incorrect predictions 212 made using machine learning model 208 from a first subset of adversarial images 204 and a set of correct predictions 214 made using the machine learning model 208 from a second subset of adversarial images.

For example, evaluation engine 122 may input individual (or as a batch) adversarial images in the set of adversarial images 204 into the machine learning model 208, the machine learning model 208 may process the image or sensor data, and the system may obtain an output from the machine learning model 208—e.g., representative of predicted probabilities for a set of object classes as the corresponding output of machine learning model 208. Evaluation engine 122 may compare the object class with the highest predicted probability to a label (or other ground truth data type) for the corresponding original image. Evaluation engine 122 may also verify that the highest predicted probability meets or exceeds a threshold. When the object class with the highest predicted probability matches the label and/or the highest predicted probability meets or exceeds the threshold, evaluation engine 122 may determine that machine learning model 208 has made a correct prediction with respect to the adversarial image. When the object class with the highest predicted probability does not match the label and/or the highest predicted probability does not meet or exceed the threshold, evaluation engine 122 may determine that machine learning model 208 has made an incorrect prediction with respect to the adversarial image. Although described as outputting probabilities, other output types are within the scope of the present disclosure. For example, the machine learning model 208 may output confidences, percentages, binary outputs (e.g., 0 or 1), and/or may regress on one or more output values.

Evaluation engine 122 uses incorrect predictions 212 and correct predictions 214 to generate two datasets associated with adversarial images 204. As shown in FIG. 2, evaluation engine 122 generates an adversarial dataset 216 that includes a set of adversarial images 220 for which the machine learning model 208 has generated incorrect predictions 212. Evaluation engine 122 also generates a clean dataset 218 that includes a different set of adversarial images 220 for which machine learning model has generated correct predictions 214. Adversarial images 220 and 222 thus correspond to two disjoint subsets of the set of adversarial images 204 inputted into machine learning model 208.

Evaluation engine 122 may populate clean dataset 218 and adversarial dataset 216 with various labels or other ground truth data types associated with the corresponding adversarial images 220 and 222. More specifically, evaluation engine 122 associates adversarial images 222 in clean dataset 218 with original labels 226 for the corresponding original images 210. Thus, clean dataset 218 includes adversarial images 222 that correspond to perturbed versions of a subset of original images 210, as well as original labels 226 that correspond to a subset of labels 206 for those original images 210.

To add labels to adversarial dataset 216, evaluation engine 122 determines perturbation strengths 240 associated with adversarial images 220 in adversarial dataset 216. Each perturbation strength represents a measure or indication of the extent by which an original image was perturbed to generate a corresponding adversarial image. For example, evaluation engine 122 may compute each perturbation strength as the number or proportion of pixels in the original image that were perturbed to generate the adversarial image, the extent to which pixel values in the original image have been perturbed to generate the adversarial image, and/or another measure of the amount of perturbation applied to the original image to generate the adversarial image. In another example, evaluation engine 122 may compute a perturbation strength as a measure of the difference between the prediction outputted by machine learning model 208 from a given adversarial image and a label for the corresponding original image. In a third example, evaluation engine 122 may compute a perturbation strength as a weighted combination of multiple measures and/or indications of the amount of perturbation associated with a corresponding adversarial image.

In some embodiments, perturbation strengths 240 are determined based on user input associated with human review of adversarial images 220 and/or the corresponding original images 210. For example, evaluation engine 122 may present one or more adversarial images 220 and a list of possible object classes for objects in the adversarial image(s) to one or more users. Each user may select the most likely object class for an object depicted in a given adversarial image. Each user may also, or instead, indicate that the object class for the object cannot be determined, given the appearance of the object in the adversarial image. An object class that is correctly identified by the user would indicate a low perturbation strength associated with the adversarial image. An object class that is incorrectly identified by the user and/or an object that is flagged by the user as having an indeterminable object class would indicate a high perturbation strength. Each user may also, or instead, provide a score, rating, and/or other input indicating the level of perturbation associated with the adversarial image (e.g., low, medium, high, etc.), given a comparison of the adversarial image with the original image from which the adversarial image was generated. When multiple users provide input related to the perturbation strength associated with a given adversarial image, the input may be averaged and/or otherwise aggregated into an overall user-specified indication of perturbation strength for the adversarial image.

After perturbation strengths 240 are computed and/or determined for adversarial images 220, evaluation engine 122 uses one or more thresholds for perturbation strengths 240 to assign labels to adversarial images 220 within adversarial dataset 216. More specifically, adversarial dataset 216 includes a first subset of adversarial images 220 that are associated with a set of original labels 224 for the corresponding original images 210. Adversarial dataset 216 also includes a second subset of adversarial images 220 that are associated with a set of adversarial labels 228.

To assign adversarial labels 228 and/or original labels 224 to adversarial images 220, evaluation engine 122 compares the perturbation strength for individual adversarial images in adversarial images 220 to a perturbation strength threshold. If the perturbation strength does not meet or exceed the threshold, evaluation engine 122 retrieves, from the set of labels 206 for the set of original images 210, a label for the original image from which the adversarial image was generated. Evaluation engine 122 adds the label to adversarial dataset 216 (e.g., as part of the set of original labels 224) and associates the label with the adversarial image (e.g., by mapping the adversarial image to the label within adversarial dataset 216). In other words, evaluation engine 122 identifies a first subset of adversarial images 220 that are associated with incorrect predictions 212 of the machine learning model 208 and perturbation strengths 240 that do not meet or do not exceed the threshold (or another threshold). Evaluation engine 122 then adds the first subset of adversarial images 220 and original labels 224 that include a subset of labels 206 for the corresponding original images 210 to adversarial dataset 216.

If the perturbation strength for a given adversarial image in adversarial images 220 meets or exceeds the threshold, evaluation engine 122 assigns an adversarial label (e.g., in adversarial labels 228) to the adversarial image within adversarial dataset 216. This adversarial label corresponds to an adversarial class that indicates that the adversarial image (or an object in the adversarial image) has been perturbed or corrupted to such an extent that the adversarial image (or object) is to be ignored or processed differently (e.g., the downstream component(s) may receive an indication of the adversarial nature of the data used to generate the output, and the downstream component(s) may perform operations in accordance with the indication) that includes the machine learning model 208.

In some embodiments, evaluation engine 122 generates adversarial labels 228 and/or original labels 224 within adversarial dataset 216 based on multiple thresholds for perturbation strengths 240. For example, evaluation engine 122 may compare computed and/or user-generated perturbation strengths 240 for adversarial images 220 with three or more thresholds or values. If an adversarial image has a computed perturbation strength that is lower than all the thresholds and/or includes a user-specified perturbation strength of low, evaluation engine 122 may generate a corresponding label that includes a value of 1 for a corresponding original label and a value of 0 for the adversarial label. If an adversarial image has a computed perturbation strength that is higher than all the thresholds and/or a user-specified perturbation strength of high, evaluation engine 122 may generate a label for the that includes a value of 0 for a corresponding original label and a value of 1 for the adversarial label.

Continuing with the above example, if an adversarial image has a computed perturbation strength that falls between two thresholds and/or a user-specified perturbation strength that falls between low and high, evaluation engine 122 may generate a corresponding label that includes a first nonzero value for a corresponding original label and a second nonzero value for the adversarial label, where the two nonzero values sum to 1. Thus, an adversarial image with a “medium low” perturbation strength may have a label with a value of 0.75 for the corresponding original label and a value of 0.25 for the adversarial label, an adversarial image with a “medium” perturbation strength may have a label with a value of 0.5 for both the corresponding original label and the adversarial label, and an adversarial image with a “medium high” perturbation strength may have a label with a value of 0.25 for the corresponding original label and a value of 0.75 for the adversarial label. Numeric values assigned to the adversarial label and original label for a given adversarial image thus represent probabilities or confidences in the object belonging to the corresponding classes. In some embodiments, where the output of the machine learning model indicates a degree or value indicating the adversarial nature of the sensor data, the downstream component(s) may perform operations differently based on the degree or value (e.g., more adversarial, disregard the output, less adversarial, use the output but weight less heavily).

After clean dataset 218 and adversarial dataset 216 are generated, refinement engine 124 uses clean dataset 218 and adversarial dataset 216 to perform additional training and/or fine-tuning of machine learning model 208. More specifically, refinement engine 124 inputs adversarial images 220 from adversarial dataset 216 into machine learning model 208 and obtains corresponding adversarial dataset predictions 260 from machine learning model 208. Adversarial dataset predictions 260 include numeric confidences representing predicted probabilities (or other output types) of various classes (or other prediction types) represented by labels 206, as well as a numeric confidence representing a predicted probability of the adversarial label for the corresponding adversarial images 220. Refinement engine 124 computes a mean squared error, cross entropy loss, and/or one or more other losses 264 between the outputted confidences and the corresponding adversarial labels 228 and/or original labels 224 for adversarial images 220. Refinement engine 124 then uses a training technique (e.g., gradient descent and backpropagation) to update model parameters 230 (e.g., weights and biases) of machine learning model 208 in a way that reduces the computed losses 264.

Refinement engine 124 also inputs each of adversarial images 222 from clean dataset 218 into machine learning model 208 and obtains corresponding clean dataset predictions 262 from machine learning model 208. Clean dataset predictions 262 may also include numeric confidences representing predicted probabilities of various classes represented by labels 206, as well as a numeric confidence representing a predicted probability of the adversarial label for the corresponding adversarial images 222. Refinement engine 124 computes a mean squared error, cross entropy loss, and/or one or more other losses 266 between the outputted confidences and the corresponding original labels 226 for adversarial images 222. Refinement engine 124 additionally uses a training technique (e.g., gradient descent and backpropagation) to update model parameters 230 of machine learning model 208 in a way that reduces the computed losses 264.

Consequently, refinement engine 124 performs one or more training stages that train machine learning model 208 to predict original labels 226 associated with adversarial images 222 in clean dataset 218. This training of machine learning model 208 using clean dataset 218 allows machine learning model 208 to continue generating correct predictions 214 for adversarial images 222 and/or other images that are similar to adversarial images 222.

Refinement engine 124 also performs one or more training stages that train machine learning model 208 to predict original labels 224 and/or adversarial labels 228 associated with adversarial images 220 in adversarial dataset 216. This training of machine learning model 208 using adversarial dataset 216 allows machine learning model 208 to learn to predict original labels 224 for adversarial images 220 associated with lower perturbation strengths 240, thereby correcting the predictive output of the machine learning model 208 with respect to these types of adversarial images 220 and/or images that are similar to these types of adversarial images 220. This training of model 208 using adversarial dataset 216 additionally allows machine learning model 208 to learn to predict adversarial labels 228 for adversarial images 220 (and/or other images that are similar to adversarial images 220) associated with higher perturbation strengths 240, thereby providing machine learning model 208 with the ability to recognize and flag adversarial data that may otherwise be used to disrupt the operation of machine learning model 208 and/or downstream components that use the output of machine learning model 208.

After model parameters 230 of machine learning model 208 have been fine-tuned by refinement engine 124 based on losses 264-266, execution engine 126 uses the fine-tuned machine learning model 208 to generate adversarial labels 234 and/or non-adversarial labels 236 for additional images 232 that are not in adversarial dataset 216 or clean dataset 218. For example, execution engine 126 may deploy and execute the machine learning model 208 within a corresponding system, such as an autonomous or semi-autonomous driving system. During operation of the autonomous or semi-autonomous vehicle or machine, images 232 of the environment around the autonomous vehicle may be captured using one or more cameras of the machine or vehicle, as described in further detail herein with respect to FIGS. 5A-5D. The captured images 232 may be input or applied to the machine learning model 208, the machine learning model 208 may process the data, and the output of the machine learning model 208 may be used to perform any of a variety of operations, such as to detect and track objects in the vicinity of a vehicle or machine. The output of the machine learning model 208 may include non-adversarial labels 236 that correspond to object classes, bounding shapes, semantic segmentations, predicted paths, and/or other output types. The output of machine learning model 208 may also, or instead, include adversarial labels 234 that indicate that the corresponding images 232 and/or regions of images 232 include adversarial data, and an indication, message, or signal indicating the same may be generated as a result.

Execution engine 126 also uses adversarial labels 234 and non-adversarial labels 236 to make certain decisions and/or perform certain actions. Continuing with the above example, execution engine 126 may provide adversarial labels 234 and non-adversarial labels 236 computed using the machine learning model 208 to one or more downstream components that use the output-such as to generate driving commands and/or make other decisions related to the operation of the autonomous or semi-autonomous machine or vehicle. Because the downstream components are aware of images 232 and/or regions of images 232 that include adversarial data, the downstream components are able to account for the adversarial nature of the data and to operate in view of this information. As a result, the machine learning model(s) 208 may be robust to adversarial attacks.

While the operation of evaluation engine 122, refinement engine 124, and execution engine 126 of FIG. 1 has been described above primarily with respect to image data and autonomous or semi-autonomous driving, it will be appreciated that evaluation engine 122, refinement engine 124, and execution engine 126 can be used to analyze and improve the performance of machine learning models 208 in resisting adversarial attacks for other types of data (e.g., LiDAR, RADAR, ultrasonic, etc.), scenarios, and/or use cases. For example, evaluation engine 122, refinement engine 124, and execution engine 126 may be used to guard against adversarial attacks that involve perturbations or modifications to other types of sensor data (as described in further detail below with respect to FIGS. 5A-5C), point cloud data, audio data, video data, text data, time-series data, network packets, source code, and/or other types of data. In another example, evaluation engine 122, refinement engine 124, and execution engine 126 may be used to improve the robustness of machine learning model 208 and downstream components against adversarial attacks that attempt to cause machine learning model 208 to generate incorrect predictions 212 related to spam filtering, detecting cybersecurity attacks, biometric recognition, medical imaging, identity fraud, and/or other applications or use cases.

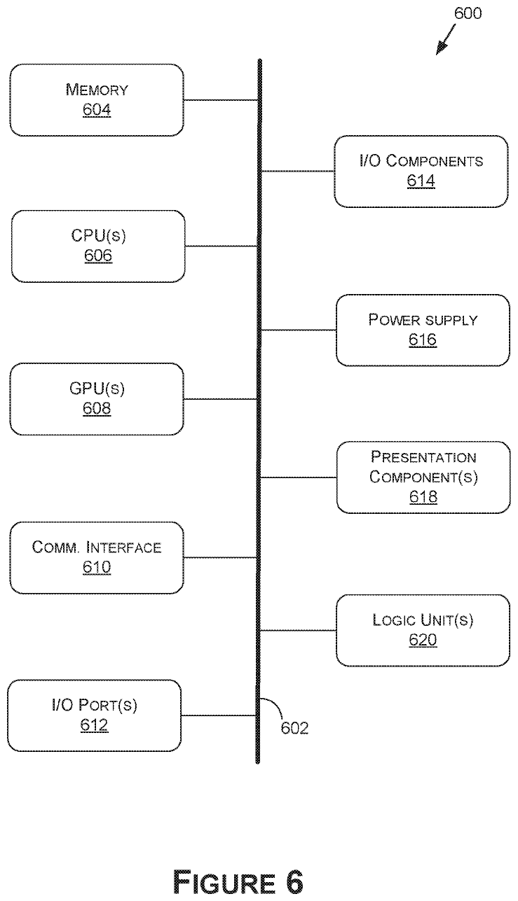

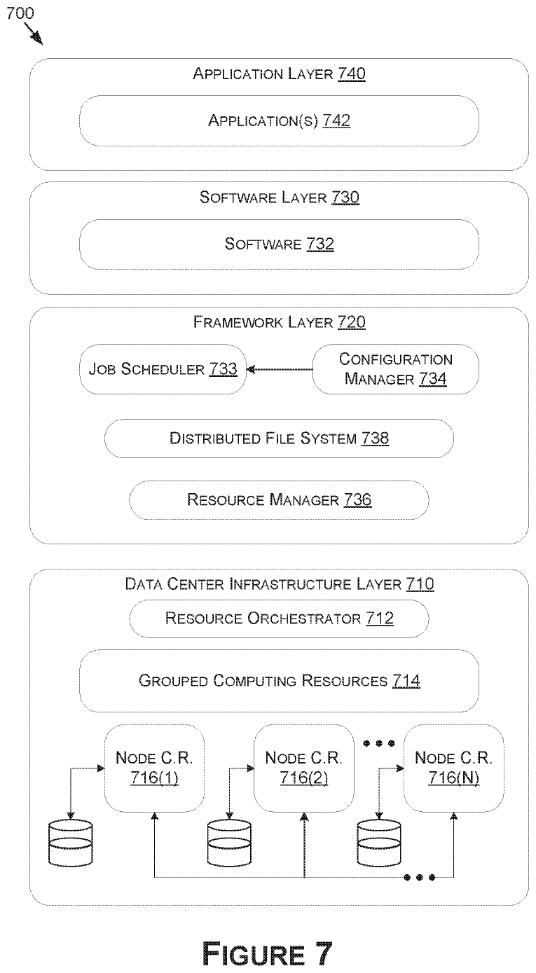

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 5A-5D, example computing device 600 of FIG. 6, and/or example data center 700 of FIG. 7.

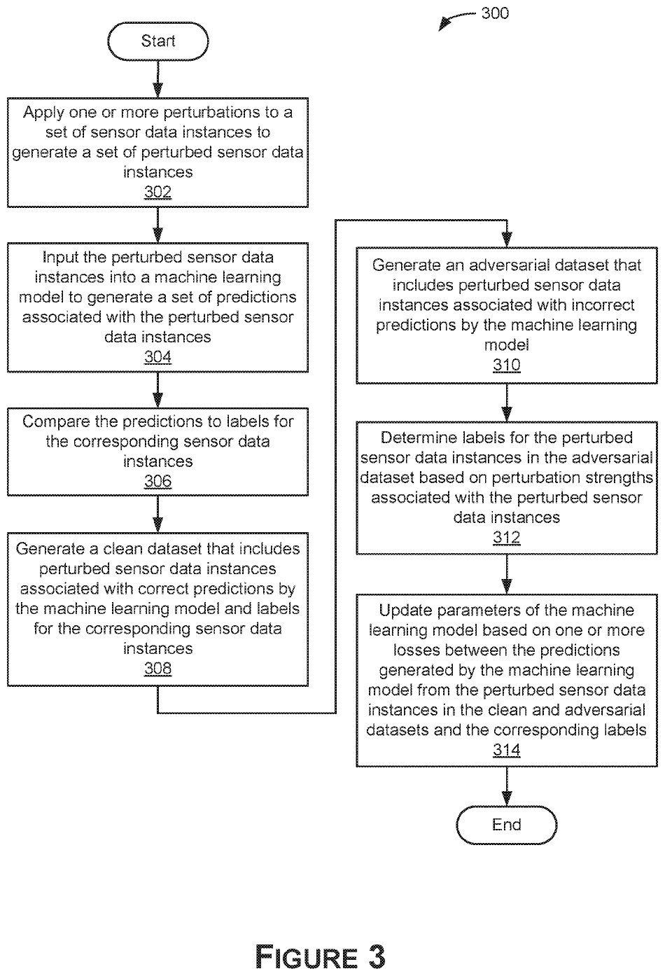

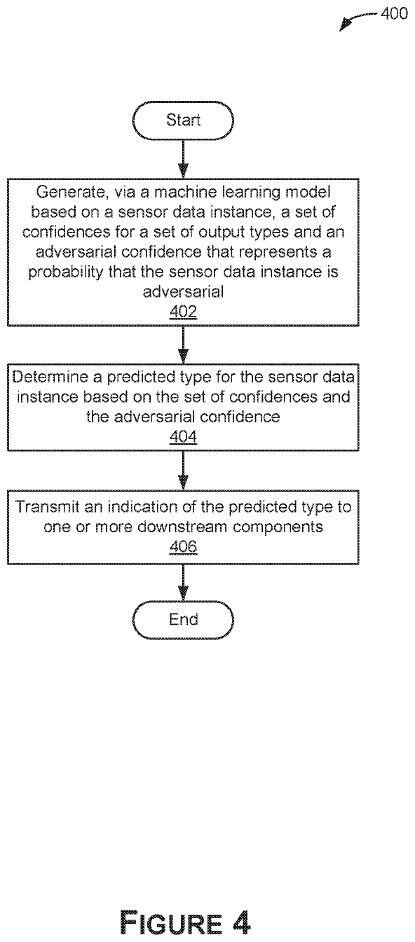

Now referring to FIGS. 3-4, each block of methods 300 and 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 300 and 400 are described, by way of example, with respect to the systems of FIGS. 1-2. However, these methods may additionally or alternatively be executed by any one system or any combination of systems, including (but not limited to) those described herein. Further, the operations in method 300 can be omitted, repeated, and/or performed in any order without departing from the scope of the present disclosure.

FIG. 3 illustrates a flow diagram of a method 300 for fine-tuning a machine learning model using adversarial data, according to various embodiments. As shown in FIG. 3, method 300 begins with operation 302, in which evaluation engine 122 applies one or more perturbations to a set of sensor data instances to generate a set of perturbed sensor data instances. For example, evaluation engine 122 may use one or more known adversarial attack techniques, one or more user-specified adversarial attack techniques, and/or a combination of adversarial attack techniques to perturb a set of “original images” captured using one or more cameras and/or synthetically generated within a simulation environment of a simulation system. The perturbed images correspond to adversarial images that can cause the machine learning model to generate incorrect predictions.

At operation 304, evaluation engine 122 inputs the perturbed sensor data instances into the machine learning model to generate a set of predictions associated with the perturbed sensor data instances. Continuing with the above example, evaluation engine 122 may process the adversarial images using a neural network to generate predictions that include, as non-limiting examples, types of objects, locations of the objects, paths of the objects, behaviors associated with the objects, and/or other attributes related to objects depicted in the adversarial images.

At operation 306, evaluation engine 122 compares the predictions to labels for the corresponding sensor data instances. Continuing with the above example, evaluation engine 122 may compare each prediction output using the neural network from an adversarial image to a label or other ground truth data type for a corresponding original image to determine if the prediction is correct or incorrect.

At operation 308, evaluation engine 122 generates a clean dataset that includes perturbed sensor data instances associated with correct predictions of the machine learning model and labels for the corresponding sensor instances. Continuing with the above example, evaluation engine 122 may populate the clean dataset with adversarial images for which the neural network correctly predicted the labels for the corresponding original images. Evaluation engine 122 may also associate the adversarial images with the labels within the clean dataset.

At operation 310, evaluation engine 122 generates an adversarial dataset that includes perturbed sensor instances associated with incorrect predictions of the machine learning model. Continuing with the above example, evaluation engine 122 may populate the adversarial dataset with adversarial images for which the neural network did not correctly predict the labels for the corresponding images.

At operation 312, evaluation engine 122 determines labels for the perturbed sensor data instances in the adversarial dataset based on perturbation strengths associated with the perturbed sensor data instances. Continuing with the above example, evaluation engine 122 may determine a perturbation strength for individual adversarial images in the adversarial dataset based on, without limitation, the number or proportion of pixels in the corresponding original image that have been perturbed, the extent to which the pixels in the original image have been perturbed, the difference between the prediction generated by the neural network from the adversarial image and the corresponding label, user input indicating the extent to which the pixels in the original image have been perturbed, and/or user input indicating the extent to which the perturbation of the original image affects a human's ability to correctly predict the label for the original image. Evaluation engine 122 may use one or more thresholds and/or values associated with the perturbation strength to assign one or more labels to the adversarial image. When the threshold(s) and/or value(s) indicate that the adversarial image is associated with a low perturbation strength, evaluation engine 122 may generate a label for the adversarial image that indicates a high confidence in the label for the original image. As the perturbation strength increases, evaluation engine 122 may lower the confidence in the label for the original image and increase the confidence in an adversarial label that indicates that the adversarial image (or an object in the adversarial image) has been perturbed or corrupted to such an extent that the adversarial image (or object) is to be disregarded and/or processed differently than if there were no adversarial nature or less than some threshold of adversarial features in the images.

At operation 314, refinement engine 124 updates parameters of the machine learning model based on one or more losses between the predictions generated using the machine learning model from the perturbed sensor data instances in the clean and adversarial datasets and the corresponding labels. Continuing with the above example, refinement engine 124 may input the adversarial images from both datasets into the neural network. For individual adversarial images, refinement engine 124 may obtain output from the neural network that includes, as a non-limiting example, predicted confidences that an object in the adversarial image belongs to various object classes and/or an adversarial class associated with the adversarial label. Refinement engine 124 may compute a mean squared error, cross entropy loss, and/or one or more other losses between the outputted confidences and one or more corresponding labels for the adversarial image in the dataset. Refinement engine 124 may then use a training technique (e.g., gradient descent and backpropagation) to update the weights of the neural network in a way that reduces the computed losses. Refinement engine 124 may continue training the neural network using the clean dataset and adversarial dataset until the weights converge; the loss(es) fall below a threshold; a certain number of training steps, iterations, batches, epochs, and/or training stages has been performed; and/or another condition is met.

Now referring to FIG. 4, FIG. 4 illustrates a flow diagram of a method 400 for processing sensor data, according to various embodiments. As shown in FIG. 4, method 400 begins with operation 402, in which execution engine 126 generates, using a machine learning model and based on a sensor data instance, a set of confidences for a set of output types and an adversarial confidence that represents a likelihood that the sensor data instance is adversarial. For example, execution engine 126 may input an image into a neural network and receive the set of confidences and adversarial confidence as a corresponding output of the neural network.

At operation 404, execution engine 126 determines a predicted type for the sensor data instance based on the set of confidences and the adversarial confidence. For example, execution engine 126 may set the predicted type to the output type with the highest confidence. If the adversarial confidence is higher than all of the other confidences, execution engine may set the predicted type to “adversarial.” Execution engine 126 may also verify that the highest confidence meets a threshold before determining the predicted type. If the highest confidence does not meet the threshold, execution engine 126 may set the predicted type to “unknown.”

At operation 406, execution engine 126 transmits an indication of the predicted type to one or more downstream components. For example, execution engine 126 may transmit the predicted type to downstream components that use the output of the machine learning model to generate driving commands and/or make other decisions related to the operation of an autonomous vehicle. Execution engine 126 may also, or instead, transmit the set of confidences and/or adversarial confidence outputted by the machine learning model to the downstream components. The downstream components would use the predicted type, set of confidences, and/or the adversarial confidence to evaluate and/or respond to the risk of an adversarial attack on the autonomous or semi-autonomous machine or vehicle.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

In some embodiments, the controller(s) 536 receive sensor data from one or more types of sensors and use one or more machine learning models to generate predictions related to the sensor data. These machine learning model(s) can be trained and/or refined to be resistant to adversarial attacks using the components and/or systems of FIGS. 1-2. The controller(s) 536 can use the predictions to generate commands or signals that are used to operate the vehicle 500.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection). These CNNs can be trained and/or refined to be resistant to adversarial attacks using the components and/or systems of FIGS. 1-2.

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O) controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508. All three neural networks may also be trained and/or refined to be robust against adversarial attacks using the systems and/or components FIGS. 1-2.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class 1 (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers). For example, the neural networks 592, the updated neural networks 592, and/or the map information 594 may be trained, refined, and/or updated to detect and guard against adversarial attacks using the systems and/or techniques described above with respect to FIGS. 1-4.

The server(s) 578 may be used to train machine learning models (e.g., machine learning model 208 of FIG. 2, neural networks, etc.) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). In some embodiments, the training data includes clean dataset 218 and/or adversarial dataset 216 of FIG. 2. Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, adversarial attack recognition, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAS, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. The machine learning model(s) may also, or instead, be refined to detect and/or resist adversarial attacks. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, the disclosed techniques perform fine-tuning of a pre-trained machine learning model using adversarial images (or other types of adversarial data). The adversarial images can be generated by perturbing a set of original images based on one or more types of adversarial attack techniques. Once generated, the adversarial images are inputted into the pre-trained machine learning model, and the predictions generated by the pre-trained machine learning model from the inputted adversarial images are compared to labels for the original images from which the adversarial images were generated. Based on these comparisons, the adversarial images are divided into a “clean” dataset of adversarial images for which the pre-trained machine learning model generated correct predictions and an “adversarial” dataset of adversarial images for which the pre-trained machine learning model generated incorrect predictions.

The machine learning model is then refined using each dataset of adversarial images and a corresponding set of labels. During the refinement process, adversarial images in the clean dataset are inputted into the machine learning model, and the machine learning model is trained based on losses between predictions generated by the machine learning model from the inputted adversarial images and labels for original images that correspond to the inputted adversarial images.

Adversarial images in the adversarial dataset are also inputted into the machine learning model, and the machine learning model is trained based on losses between predictions generated by the machine learning model from the inputted adversarial images and labels that are determined based on perturbation strengths associated with the inputted adversarial images. More specifically, adversarial images that are in the adversarial dataset and associated with perturbation strengths of less than a threshold amount are assigned labels for the corresponding original images, and adversarial images that are in the adversarial dataset and associated with perturbation strengths of greater than the threshold amount are assigned an “adversarial label” that indicates that the corresponding images (or regions of images) are to be disregarded when determining actions to be performed based on the output of the machine learning model. The machine learning model is then trained based on losses between predictions generated by the machine learning model from the inputted adversarial images and the corresponding labels.

After the machine learning model has been trained using the adversarial images and corresponding labels, the machine learning model can be used in a visual ADS and/or another type of system to generate predictions for additional images. For example, the machine learning model may be used to detect and/or track objects in the vicinity of a self-driving car during operation of the self-driving car. The output of the machine learning model may be provided to one or more downstream components that generate commands and/or signals that are used to operate the self-driving car.

One technical advantage of the disclosed technique relative to the prior art is that a machine learning model is able to detect and correct for adversarial data that attempts to cause the machine learning model to operate incorrectly. Accordingly, a system that utilizes the output of the machine learning model is safer and more resistant to adversarial attacks than conventional systems that include machine learning models that have not been trained to recognize and/or defend against adversarial attacks. Another technical advantage of the disclosed techniques is a reduction in computational overhead and resource consumption, compared with prior art approaches that use an ensemble of multiple machine learning models to guard against adversarial attacks. These technical advantages provide one or more technological improvements over prior art approaches.

1. In some embodiments, a method comprises generating, using a machine learning model and based at least on a sensor data instance, one or more base outputs and one or more adversarial outputs that represent a likelihood that the sensor data instance is adversarial; determining that the sensor data instance is adversarial based on the one or more adversarial outputs; and sending, to one or more downstream components, an indication that the sensor data instance is adversarial to cause the one or more downstream components to perform one or more operations with respect to the one or more base outputs and in view of the indication.

2. The method of clause 1, further comprising generating, using the machine learning model and based at least on a second sensor data instance, one or more second base outputs and one or more second adversarial outputs that represent a likelihood that the second sensor data instance is adversarial: determining, using the one or more second base outputs, an output type corresponding to the second sensor data instance based at least on the one or more second adversarial outputs; and sending a second indication of the output type corresponding to the second sensor data instance to the one or more downstream components.

3. The method of any of clauses 1-2, wherein the determining the output type comprises matching a highest confidence included in the one or more second base outputs and the one or more second adversarial outputs to the output type.

4. The method of any of clauses 1-3, wherein the machine learning model was trained based at least on updating one or more parameters of the machine learning model based at least on one or more losses associated with a set of adversarial sensor data instances processed using the machine learning model.

5. The method of any of clauses 1-4, wherein the one or more losses are computed using a set of outputs generated using the machine learning model from the set of adversarial sensor data instances and a set of labels corresponding to the set of adversarial sensor data instances, wherein the set of labels comprises (1) an original label for an original sensor data instance that has been perturbed to produce a first adversarial sensor data instance included in the set of adversarial sensor data instances, and (2) an adversarial label indicating that a second adversarial sensor data instance included in the set of adversarial sensor data instances corresponds to an adversarial attack.

6. The method of any of clauses 1-5, wherein the determining that the sensor data instance is adversarial comprises determining that at least one of the one or more adversarial outputs exceeds a threshold value.

7. The method of any of clauses 1-6, wherein the determining that the sensor data instance is adversarial comprises determining that the one or more adversarial outputs include confidences that are higher than confidences associated with the one or more base outputs.

8. The method of any of clauses 1-7, wherein the sensor data instance comprises one or more images.

9. The method of any of clauses 1-8, wherein the one or more base outputs correspond to a set of classes associated with objects.

10. The method of any of clauses 1-9, wherein the one or more downstream components are included in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.

11. In some embodiments, a method comprises generating, using a machine learning model and based at least on a perturbed sensor data instance, an output that includes a base output and an adversarial output, the adversarial output corresponding to a likelihood that the perturbed sensor data instance is adversarial; computing one or more loss values based at least on the base output, the adversarial output, and ground truth data indicating that the perturbed sensor data instance is adversarial; and updating one or more parameters of the machine learning model based at least on the one or more loss values.

12. The method of clause 11, further comprising generating, using the machine learning model and based at least on a second perturbed sensor data instance, a second base output and a second adversarial output, the second adversarial output corresponding to a likelihood that the second perturbed sensor data instance is adversarial: computing one or more second loss values based at least on the second base output, the second adversarial output, and second ground truth data corresponding to an original sensor data instance that was perturbed to generate the second perturbed sensor data instance; and updating at least one of the one or more parameters or one or more other parameters of the machine learning model based at least on the one or more second loss values.

13. The method of any of clauses 11-12, further comprising assigning the second ground truth data to the second perturbed sensor data instance based at least on a match between the second ground truth data and a previous output generated using the machine learning model based at least on the second perturbed sensor data instance.

14. The method of any of clauses 11-13, further comprising determining the second ground truth data based at least on a perturbation strength associated with the second perturbed sensor data instance falling below a threshold perturbation strength.

15. The method of any of clauses 11-14, wherein the computing the one or more second loss values is further based at least on the second base output and third ground truth data that indicates that the second perturbed sensor data instance corresponds to an adversarial attack, wherein the second ground truth data comprises a first target probability for an output type of the second base output and the third ground truth data comprises a second target probability of the second adversarial output.

16. The method of any of clauses 11-15, further comprising determining the ground truth data based at least on a perturbation strength associated with the perturbed sensor data instance exceeding a threshold perturbation strength.

17. The method of any of clauses 11-16, further comprising applying one or more perturbations to an original sensor data instance to generate the perturbed sensor data instance.

18. The method of any of clauses 11-17, wherein the one or more perturbations comprise at least one of a fast gradient step method (FGSM), a projected gradient descent (PGD) technique, a limited-memory Broyden-Fletcher-Goldfarm-Shannon (L-BGFS) technique, a Carlini & Wagner technique, a Jacobian-based Saliance Map Attack (JSMA), or a DeepFool technique.

19. In some embodiments, a system comprises one or more processing units to perform, based at least on an indication of an adversarial attack, one or more operations with respect to a base output of a neural network, the indication of the adversarial attack generated based at least on an adversarial output of the neural network different than the base output.

20. The system of claim 19, wherein the system is comprised in at least one of a control system for an autonomous or semi-autonomous machine; a perception system for an autonomous or semi-autonomous machine: a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations: a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method, comprising:
generating, using a machine learning model and based at least on a sensor data instance, one or more base outputs and one or more adversarial outputs that represent a likelihood that the sensor data instance is adversarial;
determining that the sensor data instance is adversarial based on the one or more adversarial outputs; and
sending, to one or more downstream components, an indication that the sensor data instance is adversarial to cause the one or more downstream components to perform one or more operations with respect to the one or more base outputs and in view of the indication.

2. The method of claim 1, further comprising:
generating, using the machine learning model and based at least on a second sensor data instance, one or more second base outputs and one or more second adversarial outputs that represent a likelihood that the second sensor data instance is adversarial;
determining, using the one or more second base outputs, an output type corresponding to the second sensor data instance based at least on the one or more second adversarial outputs; and
sending a second indication of the output type corresponding to the second sensor data instance to the one or more downstream components.

3. The method of claim 2, wherein the determining the output type comprises matching a highest confidence included in the one or more second base outputs and the one or more second adversarial outputs to the output type.

4. The method of claim 1, wherein the machine learning model was trained based at least on updating one or more parameters of the machine learning model based at least on one or more losses associated with a set of adversarial sensor data instances processed using the machine learning model.

5. The method of claim 4, wherein the one or more losses are computed using a set of outputs generated using the machine learning model from the set of adversarial sensor data instances and a set of labels corresponding to the set of adversarial sensor data instances, wherein the set of labels comprises (1) an original label for an original sensor data instance that has been perturbed to produce a first adversarial sensor data instance included in the set of adversarial sensor data instances, and (2) an adversarial label indicating that a second adversarial sensor data instance included in the set of adversarial sensor data instances corresponds to an adversarial attack.

6. The method of claim 1, wherein the determining that the sensor data instance is adversarial comprises determining that at least one of the one or more adversarial outputs exceeds a threshold value.

7. The method of claim 1, wherein the determining that the sensor data instance is adversarial comprises determining that the one or more adversarial outputs include confidences that are higher than confidences associated with the one or more base outputs.

8. The method of claim 1, wherein the sensor data instance comprises one or more images.

9. The method of claim 1, wherein the one or more base outputs correspond to a set of classes associated with objects.

10. The method of claim 1, wherein the one or more downstream components are included in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

11. A method, comprising:
generating, using a machine learning model and based at least on a perturbed sensor data instance, an output that includes a base output and an adversarial output, the adversarial output corresponding to a likelihood that the perturbed sensor data instance is adversarial;
computing one or more loss values based at least on the base output, the adversarial output, and ground truth data indicating that the perturbed sensor data instance is adversarial; and
updating one or more parameters of the machine learning model based at least on the one or more loss values.

12. The method of claim 11, further comprising:
generating, using the machine learning model and based at least on a second perturbed sensor data instance, a second base output and a second adversarial output, the second adversarial output corresponding to a likelihood that the second perturbed sensor data instance is adversarial;
computing one or more second loss values based at least on the second base output, the second adversarial output, and second ground truth data corresponding to an original sensor data instance that was perturbed to generate the second perturbed sensor data instance; and
updating at least one of the one or more parameters or one or more other parameters of the machine learning model based at least on the one or more second loss values.

13. The method of claim 12, further comprising assigning the second ground truth data to the second perturbed sensor data instance based at least on a match between the second ground truth data and a previous output generated using the machine learning model based at least on the second perturbed sensor data instance.

14. The method of claim 12, further comprising determining the second ground truth data based at least on a perturbation strength associated with the second perturbed sensor data instance falling below a threshold perturbation strength.

15. The method of claim 12, wherein the computing the one or more second loss values is further based at least on the second base output and third ground truth data that indicates that the second perturbed sensor data instance corresponds to an adversarial attack, wherein the second ground truth data comprises a first target probability for an output type of the second base output and the third ground truth data comprises a second target probability of the second adversarial output.

16. The method of claim 11, further comprising determining the ground truth data based at least on a perturbation strength associated with the perturbed sensor data instance exceeding a threshold perturbation strength.

17. The method of claim 11, further comprising applying one or more perturbations to an original sensor data instance to generate the perturbed sensor data instance.

18. The method of claim 17, wherein the one or more perturbations comprise at least one of a fast gradient step method (FGSM), a projected gradient descent (PGD) technique, a limited-memory Broyden-Fletcher-Goldfarm-Shannon (L-BGFS) technique, a Carlini & Wagner technique, a Jacobian-based Saliance Map Attack (JSMA), or a DeepFool technique.

19. A system comprising:
one or more processing units to perform, based at least on an indication of an adversarial attack, one or more operations with respect to a base output of a neural network, the indication of the adversarial attack generated based at least on an adversarial output of the neural network different than the base output.

20. The system of claim 19, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
